(19) United States
(12) Patent Application Publication
(10) Pub. No.: US 2012/0056608 A1
(43) Pub. Date: Mar. 8, 2012

(54) STABILIZING NETWORK FOR ELECTRONIC TRANSFORMER DRIVEN LED DEVICES

(76) Inventors: Johnny SIU, Hong Kong (CN); Wa-Hing Leung, Hong Kong (CN)

(21) Appl. No.: 12/959,178

(22) Filed: Dec. 2, 2010

Related U.S. Application Data
(60) Provisional application No. 61/380,932, filed on Sep. 8, 2010.

(51) Int. Cl. G05F 3/08

(52) U.S. Cl. 323/305

(57) ABSTRACT

A stabilization circuit is provided at an output of an electronic transformer driving circuit having a rectifier fed into a feedback-controlled oscillator circuit that drives an isolation transformer at an output of the electronic transformer driving circuit. The stabilization circuit includes: a current limiting portion that limits an amount of current delivered by the electronic transformer driving circuit.

### CROSS-REFERENCE TO RELATED APPLICATION

This application claims benefit under 35 U.S.C. §119(e) to U.S. Provisional Patent Application Ser. No. 61/380,932, filed Sep. 8, 2010, which is hereby incorporated by reference.

### BACKGROUND OF THE INVENTION

The present invention generally relates to a circuit for stabilizing electronic transformer driven LED devices.

Conventionally, low voltage halogen lamps, such as the MR16 multifaceted reflector lamp, or the aluminum reflector AR111, need a transformer to provide the lamp with a low voltage supply from either 110 Vac or 220 Vac mains. There are two types of transformer used for this purpose—magnetic and electronic. Most halogen lamps are driven by electronic transformers, which are cheaper, smaller and lighter than magnetic transformers.

FIG. 1 shows a typical schematic of a conventional electronic transformer 5 of the type used in driving a halogen light L1. In the circuit, the AC input line voltage is first rectified by the diodes in diode bridge DB1, and the resultant rectified signal is fed into an oscillator, which drives the isolation transformer T2. At the output of the circuit, the secondary output winding of transformer T2 is directly connected to the halogen lamp L1.

The frequency of oscillation of the circuit depends mainly upon the size and maximum flux density of the core used in the feedback transformer T1. When the oscillation cycle has started by the RC circuit, the current in the feedback transformer T1 increases until the core saturates. At this point the feedback drive of the active transistor TR2 is removed, turning TR2 off. In typical use, the oscillation frequency is approximately 30 to 40 kHz. An electronic transformer such as the one shown in FIG. 1 works well with halogen lamps, which act as a resistive load to the transformer.

FIG. 2 shows the output voltage waveform of electronic transformer driving halogen lamp. The voltage is continuous throughout a half line cycle.

Retrofit LED lamps are becoming more popular because of low power consumption and long life expectancy. Such LED lamps, which are intended to replace low voltage halogen lamps, need a built-in circuitry to drive the LEDs inside. FIG. 3 shows the schematic of a typical built-in driver of LED lamps.

As can be seen in FIG. 3, diode bridge consisting of diodes D1 to D4 and a bulk capacitor C1 form the input stage of the LED driver circuit 6. The LED driver circuit 6 may be chosen from among the standard LED driver circuits available, which are known to those skilled in the art, such as ZXLD1356 shown in FIG. 4. The ZXLD1356, in conjunction with the inductor L1, diode D1 and current sense resistor Rs, forms a step-down buck converter. It is designed for driving single or multiple series connected LEDs from a voltage source higher than the LED forward voltage. The LED current value is set by external resistor Rs. By applying an external control signal to the ‘ADJ’ pin, output current can be adjusted above, or below the set value. In a typical configuration, the electronic transformer would be coupled to the circuit shown in FIG. 3 such that its input would be connected to line voltage (110/220 Vac) and its output would be low voltage ac/dc, and be connected to the input of the LED driver. However, when such an LED lamp is connected to an electronic transformer, it causes two problems.

First, the peak charging current of the capacitor C1 is large and it may exceed the design limit of the electronic transformer. This large charging current can result in a failure of components of the transformer circuit, such as the transistors.

Second, electronic transformers are designed to work with resistive loads with a specific power consumption. LED lamps with built-in driving circuits, which are capacitive loads, actually draw much less average current (although the peak current may be higher) than halogen lamps. Thus, when the electronic transformer is connected with an LED lamp as its load, the oscillator circuit of electronic transformer may become unstable because only a small amount of current, or even no current, may flow through its feedback circuit to sustain the oscillation.

FIG. 5 shows the output voltage waveform of an electronic transformer when it is driving an LED lamp. It can be seen that the electronic transformer is working discontinuously and may cause visible flickers. FIG. 6 shows the output current which only flows when the output voltage is around its peak level.

### BRIEF SUMMARY OF THE INVENTION

In accordance with one aspect of the present invention, a stabilization circuit is provided at an output of an electronic transformer driving circuit having a rectifier fed into a feedback-controlled oscillator circuit that drives an isolation transformer at an output of the electronic transformer driving circuit. The stabilization circuit includes: a current limiting portion that limits an amount of current delivered by the electronic transformer driving circuit.

In another aspect, the stabilization circuit further includes: a bypass current path that maintains stable operation of the feedback-controlled oscillator to regulate the current that flows to an output of the electronic transformer driving circuit.

In another aspect, the bypass current path includes a resistor in series with a capacitor.

In another aspect, the bypass current path includes, a resistor, an inductor, and a capacitor in series.

In another aspect, the bypass current path includes a capacitor in series with a parallel combination of an inductor and a resistor.

In another aspect, the bypass current path includes a capacitor and a resistor in series with a parallel combination of an inductor and a second resistor.

In another aspect, the bypass current path includes an inductor in series with a capacitor.

In another aspect, the bypass current path includes a capacitor.

In another aspect, the current limiting portion includes a current limiting resistor in series with a current limiting inductor.

In another aspect, the current limiting portion includes a current limiting inductor.

### BRIEF DESCRIPTION OF THE DRAWINGS

The figures are for illustration purposes only and are not necessarily drawn to scale. The invention itself, however, may best be understood by reference to the detailed description which follows when taken in conjunction with the accompanying drawings in which:

FIG. 1 is a schematic diagram of a conventional electronic transformer circuit for supplying power to a lighting device;

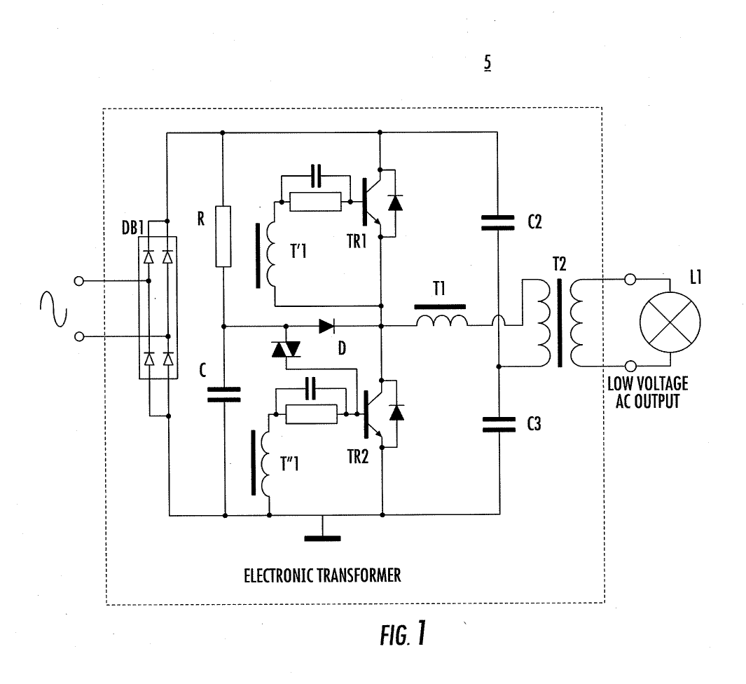

FIG. 2 is a diagram showing an output voltage waveform of the conventional electronic transformer circuit of FIG. 1 driving halogen lamp;

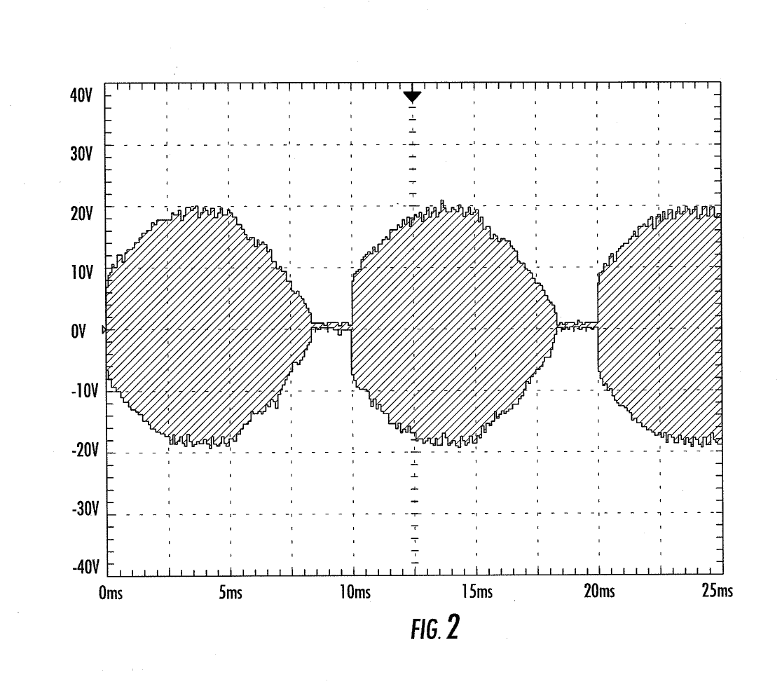

FIG. 3 is a schematic diagram of a typical built-in driver for LED lamps;

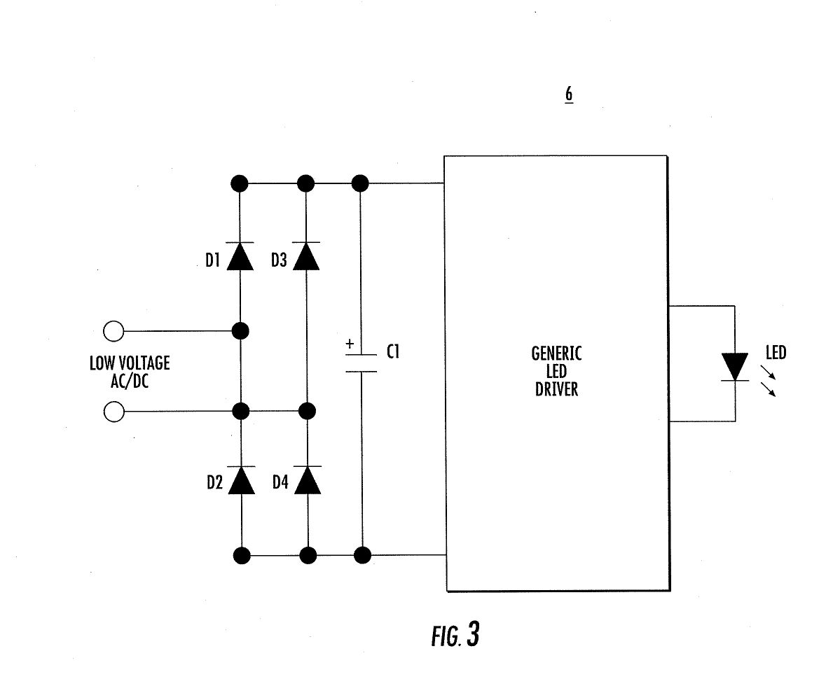

FIG. 4 is a diagram showing an LED driver using ZXLD1356;

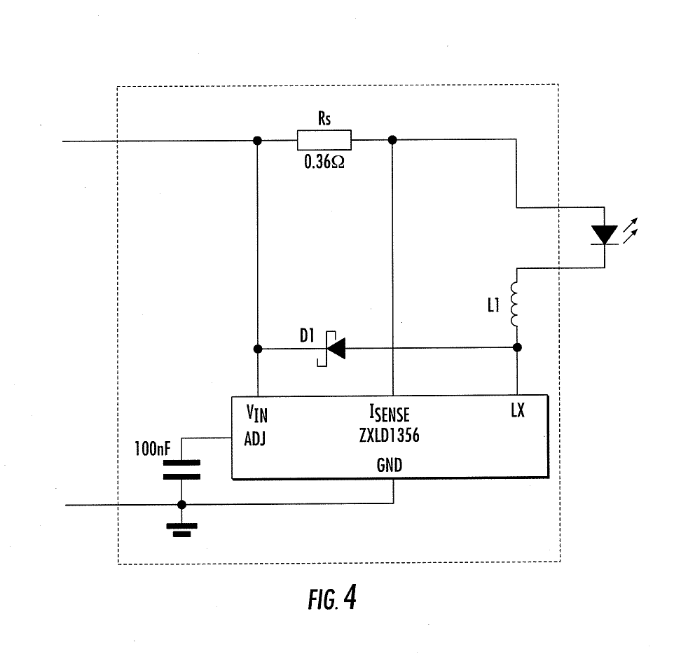

FIG. 5 is a diagram showing an output voltage waveform of an electronic transformer driving an LED lamp;

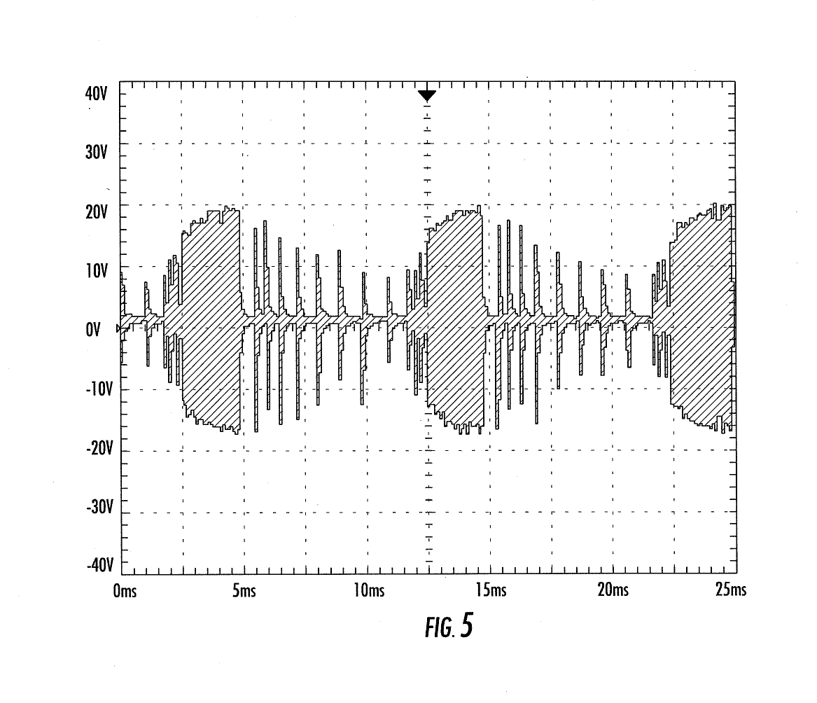

FIG. 6 is a diagram showing an output current waveform of an electronic transformer driving an LED lamp;

FIG. 7 is a diagram of a circuit to stabilize an electronic transformer driving LED lamps, accordance with an embodiment of the present invention;

FIG. 8 is a diagram of showing the complete connections of an electronic transformer, a stabilizing circuit in accordance with an embodiment of the present invention and a LED driver;

FIG. 9 is a diagram of an output voltage waveform of an electronic transformer driving an LED lamp with the stabilizing circuit shown in FIG. 7;

FIG. 10 is a diagram of an output current waveform of an electronic transformer driving an LED lamp with stabilizing circuit shown in FIG. 7;

FIGS. 11A-11F are diagrams showing variations of the stabilizing circuit in accordance with embodiments of the present invention;

FIG. 12 is a diagram of an output voltage waveform of an electronic transformer driving an LED lamp with the stabilizing circuit shown in FIG. 11A;

FIG. 13 is a diagram of an output current waveform of an electronic transformer driving an LED lamp with stabilizing circuit shown in FIG. 11A;

FIG. 14 is a diagram of an output voltage waveform of an electronic transformer driving an LED lamp with the stabilizing circuit shown in FIG. 11B;

FIG. 15 is a diagram of an output current waveform of an electronic transformer driving an LED lamp with stabilizing circuit shown in FIG. 11B;

FIG. 16 is a diagram of an output voltage waveform of an electronic transformer driving an LED lamp with the stabilizing circuit shown in FIG. 11C;

FIG. 17 is a diagram of an output current waveform of an electronic transformer driving an LED lamp with stabilizing circuit shown in FIG. 11C;

FIG. 18 is a diagram of an output voltage waveform of an electronic transformer driving an LED lamp with the stabilizing circuit shown in FIG. 11D;

FIG. 19 is a diagram of an output current waveform of an electronic transformer driving an LED lamp with stabilizing circuit shown in FIG. 11D;

FIG. 20 is a diagram of an output voltage waveform of an electronic transformer driving an LED lamp with the stabilizing circuit shown in FIG. 11E;

FIG. 21 is a diagram of an output current waveform of an electronic transformer driving an LED lamp with stabilizing circuit shown in FIG. 11E;

FIG. 22 is a diagram of an output voltage waveform of an electronic transformer driving an LED lamp with stabilizing circuit shown in FIG. 11F; and

FIG. 23 is a diagram of an output current waveform of an electronic transformer driving an LED lamp with stabilizing circuit shown in FIG. 11F.

### DETAILED DESCRIPTION OF THE INVENTION

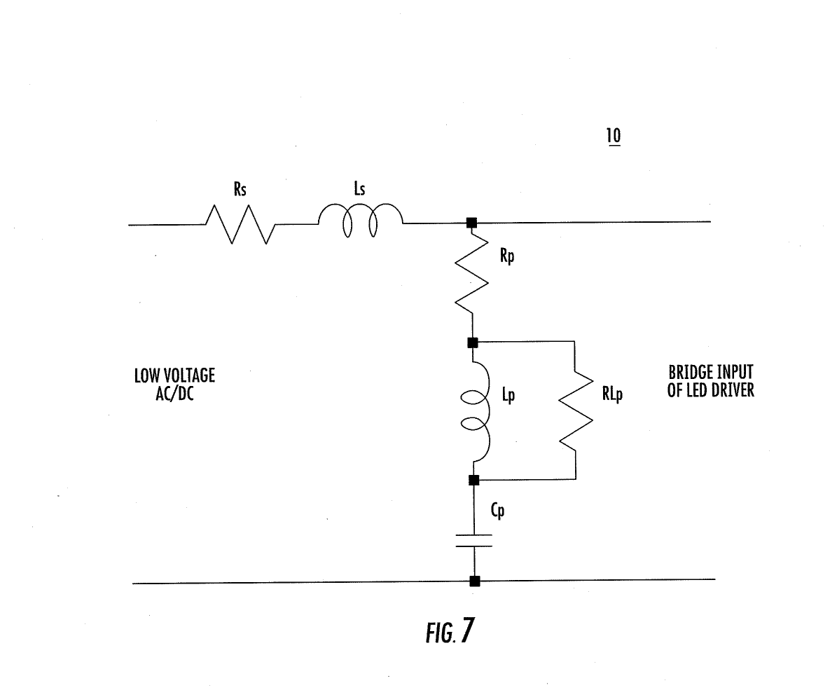

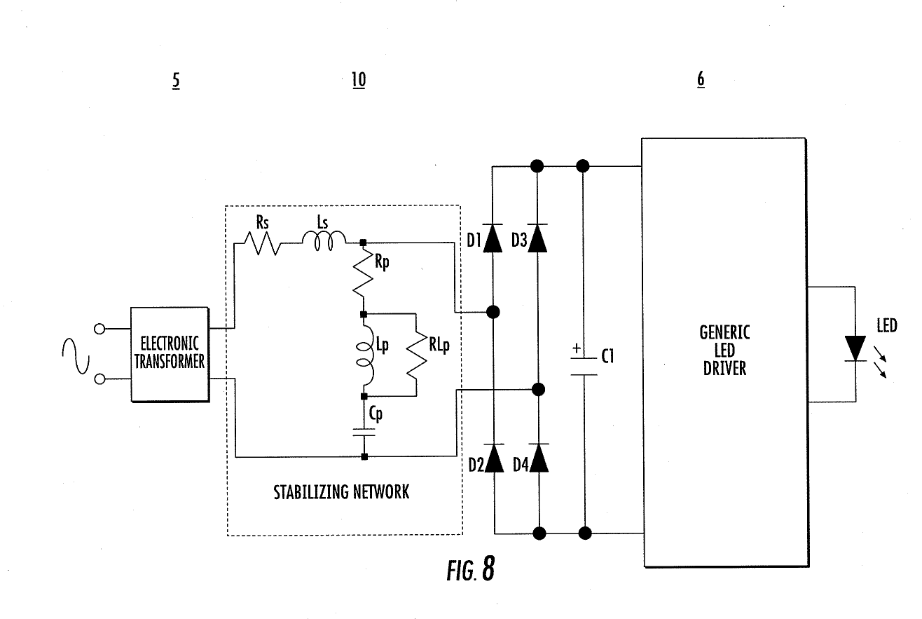

FIG. 7 is a diagram of stabilizing circuit 10, presented in its general form, that overcomes the abovementioned problems with electronic transformers. The circuit would be added to the bridged input of the LED driver 6. Low-voltage LED lamps are usually powered by 12V AC/DC sources. FIG. 8 shows the complete connections of an electronic transformer 5 a stabilizing circuit 10 and an LED driver 6. In the stabilizing circuit 10, resistor Rs and inductor Ls are provided in series and limit the current drawn by the LED driver. At the oscillating frequency of the electronic transformer, the impedance of the inductor Ls becomes large and current drawn by the LED driver is limited. At mains frequency (i.e., 50/60 Hz) or below (for example, when magnetic transformers or DC power supplies/batteries are used instead of electronic transformers), the impedance of Ls becomes small and current to LED driver would not be limited.

In the circuit of FIG. 8, a resistor Rs, an inductor Ls, a resistor Rp, an inductor Lp, a resistor RLp and capacitor Cp provide a bypass current path for the electronic transformer to keep the oscillator running. The inductor Lp is only used to limit the bypass current. Resistors Rp and RLp are used to make the overall impedance more resistive, which simulates the loading of a halogen lamp. When operating at the oscillating frequency of electronic transformers, the impedance of capacitor Cp is small and the bypass current is allowed to flow. When operating at mains frequency or below, impedance of Cp is large and bypass current is small or even stopped, hence power dissipation in resistors of the stabilizing network is minimized.

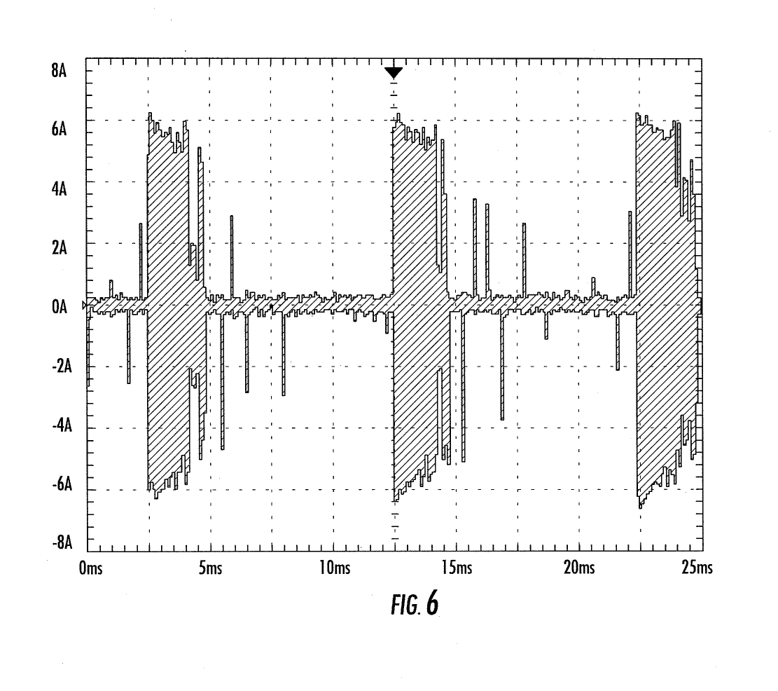

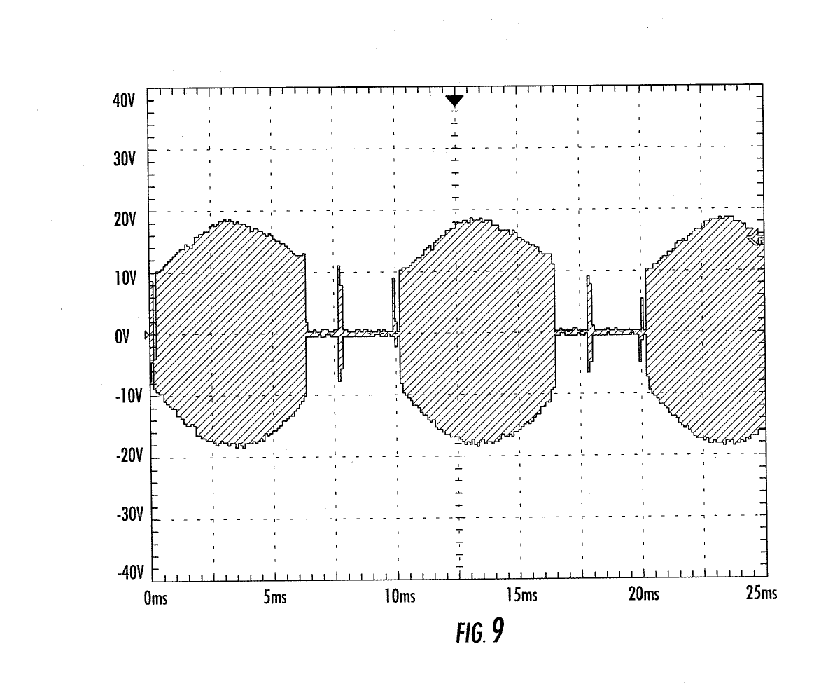

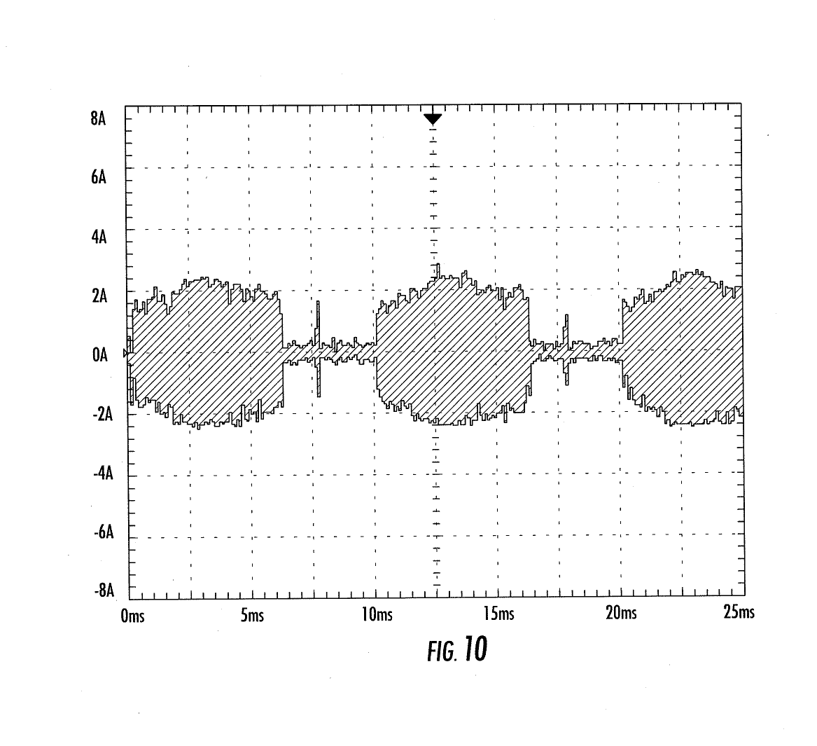

FIG. 9 shows the output voltage waveform of an electronic transformer driving a LED device with stabilizing circuit shown in FIG. 7. It can be seen that the output voltage is continuous over a half line cycle. FIG. 10 shows the corresponding output current waveform. From the figure, the peak current is reduced as compared with FIG. 6. The output current also flows continuously over a half line cycle

Although shown in the figures in the context of an electronic transformer, the stabilizing circuit in accordance with the disclosed embodiment can be used in conjunction with magnetic transformers, and with DC power supplies/batteries. In particular, the stabilizing circuit in accordance with the present invention will minimize power dissipation when it is connected to magnetic transformers and DC power supplies/batteries.

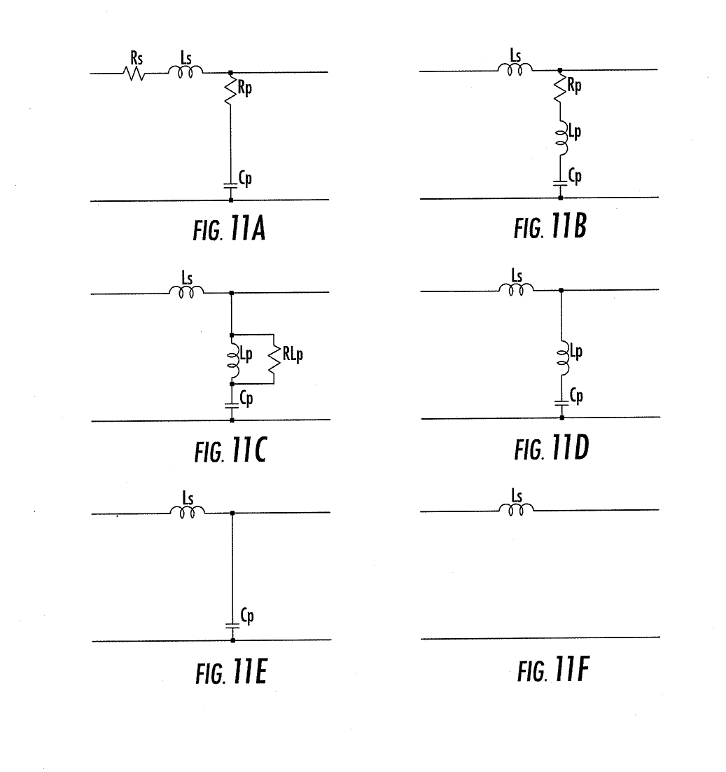

FIG. 7 shows the general embodiment of the stabilizing circuit. However, other variations of the circuit can be employed, and the circuit can be reduced to its simplest form which uses inductor Ls only. FIGS. 11A-11F show variations of the stabilizing circuit.

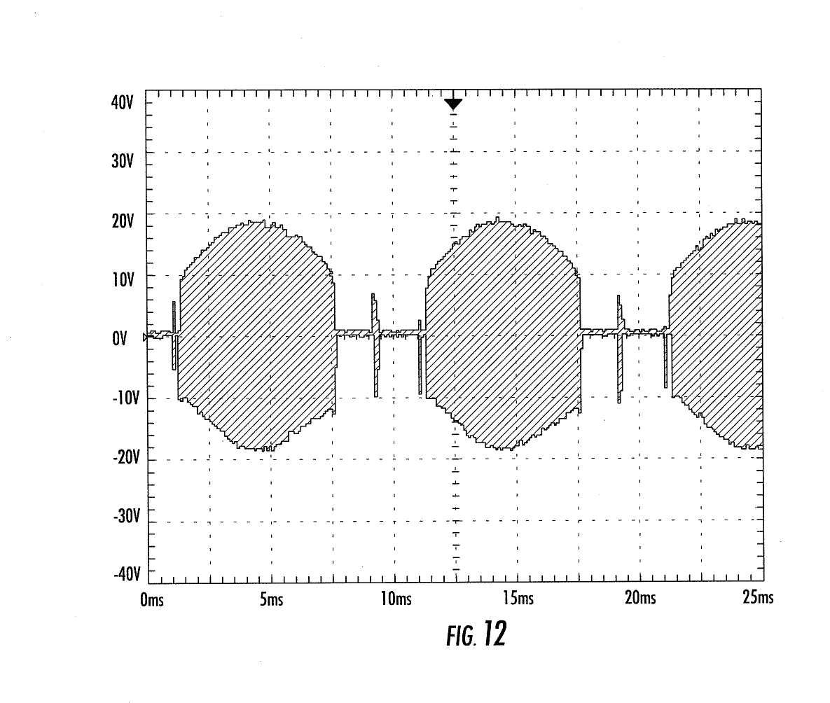

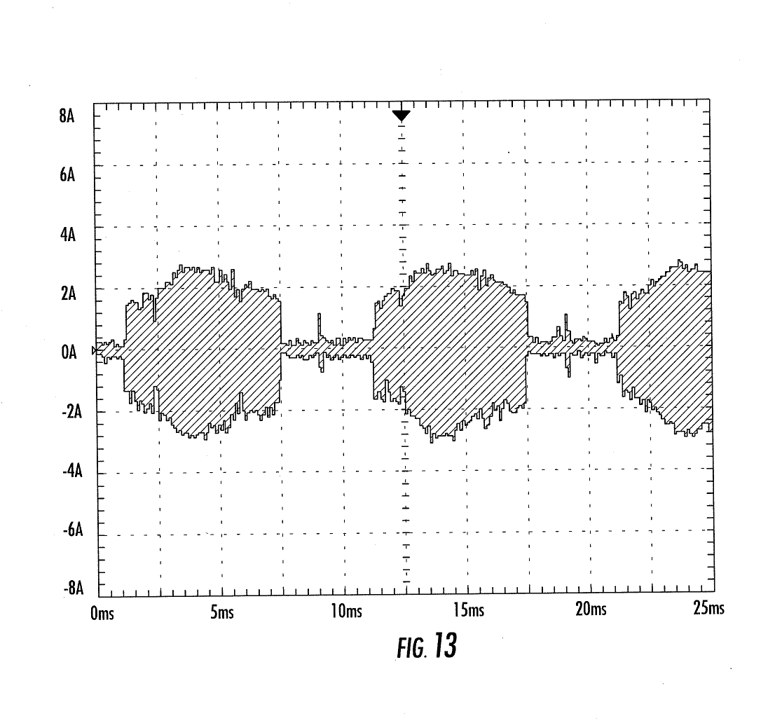

FIG. 12 shows the output voltage waveform of an electronic transformer driving a LED device with stabilizing circuit shown in FIG. 11A. In the circuit of FIG. 11A the bypass portion of the circuit includes resistor Rp in series with capacitor Cp. The output voltage is continuous over a half line cycle. FIG. 13 shows the corresponding output current waveform. It can be seen from the figure that the peak current is reduced. The output current also flows continuously over a half line cycle.

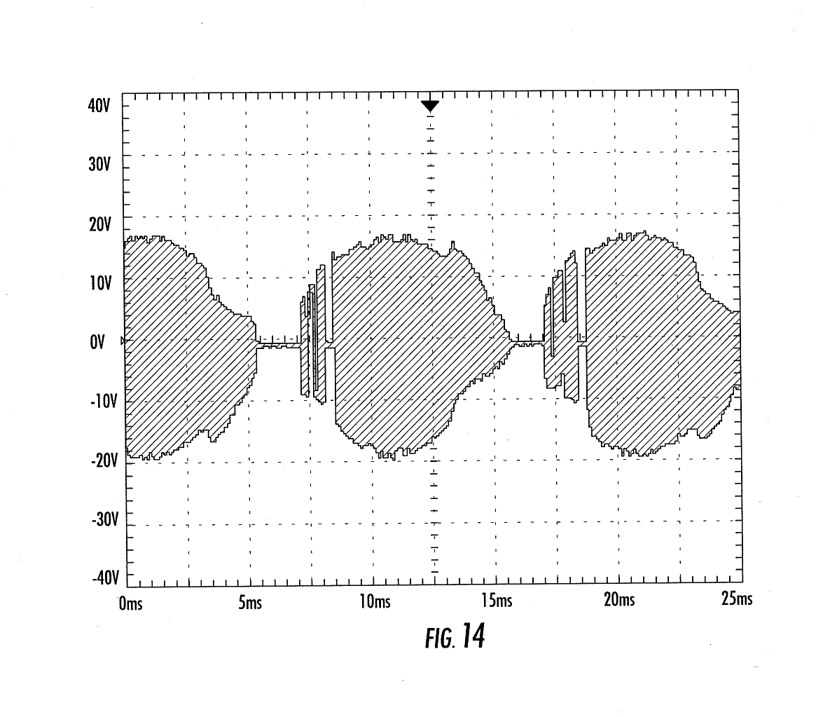

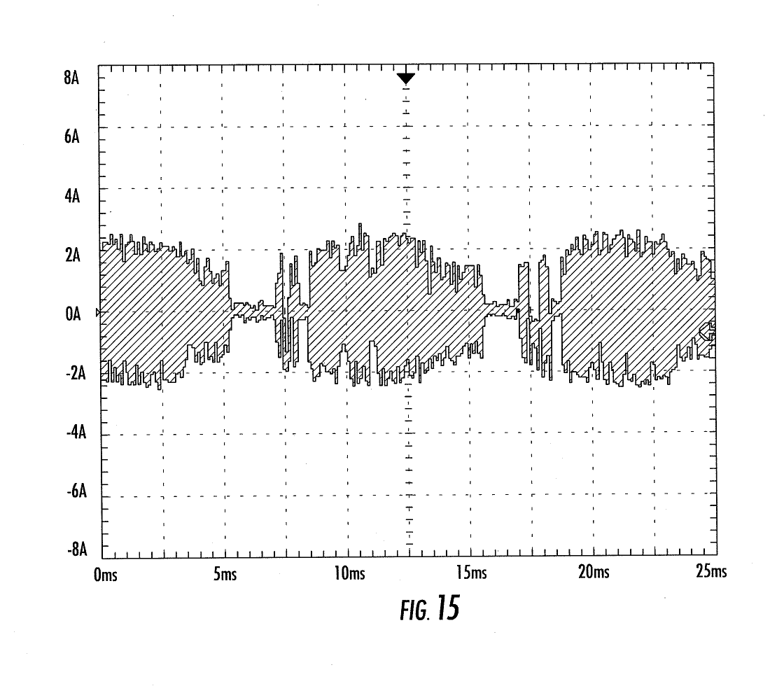

FIGS. 14 and 15 show the output voltage and current waveforms of an electronic transformer driving a LED device with the stabilizing circuit shown in FIG. 11B. Since the bypass current is limited by the addition of inductor Lp in this embodiment, there are short discontinuous periods in the waveforms. Again, the peak current is reduced.

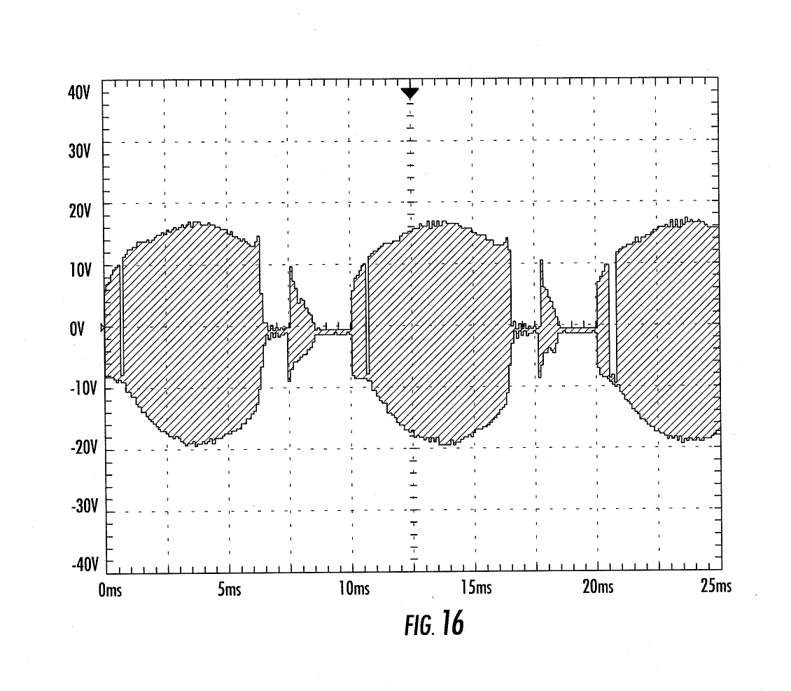

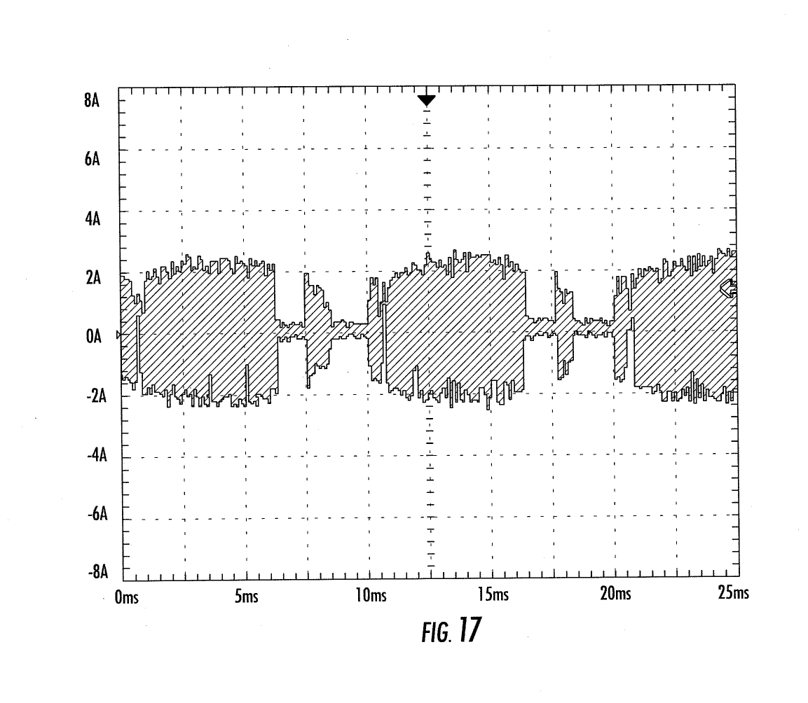

FIGS. 16 and 17 show the output voltage and current waveforms of an electronic transformer driving a LED device with the stabilizing circuit shown in FIG. 11C. It can be seen that the peak current is reduced. In this embodiment, the bypass portion of the circuit includes inductor Lp in parallel with resistor RLp. Also included is the capacitor Cp. Similar to embodiment shown in FIG. 7, the bypass current is limited by the parallel combination of the inductor Lp and the resistor RLp in this embodiment, and, as can be seen in FIGS. 16 and 17, there are discontinuous periods in the waveforms.

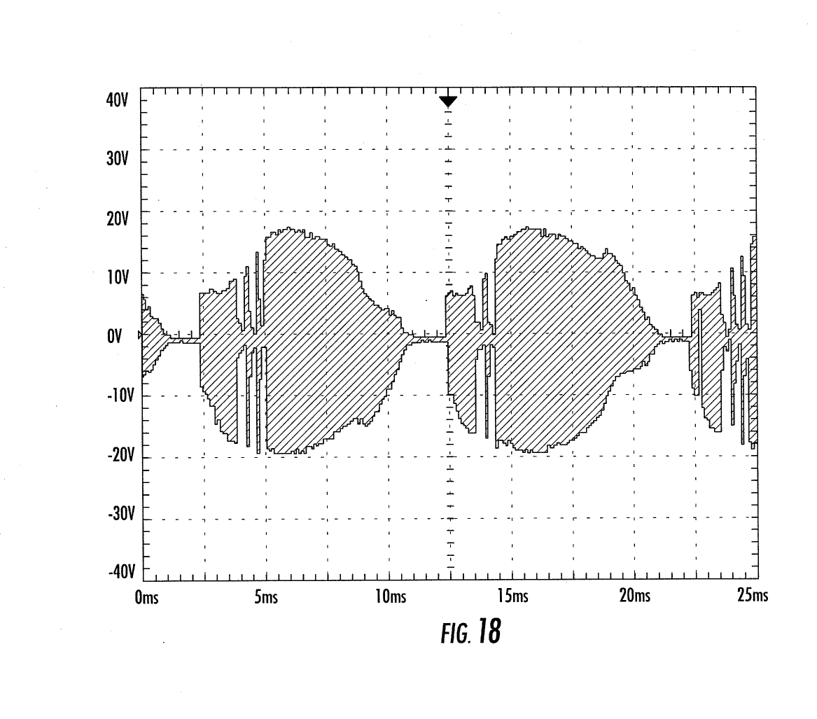

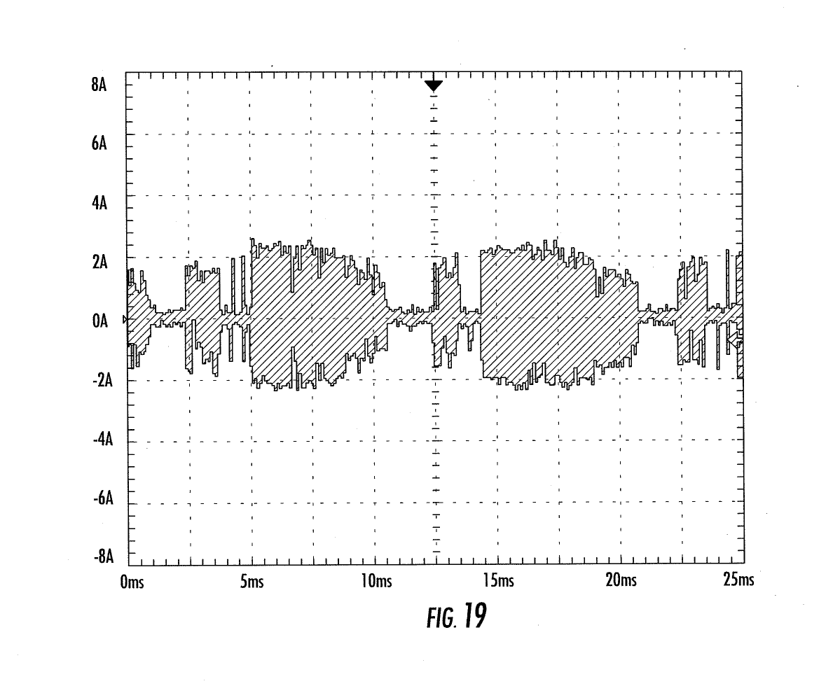

FIGS. 18 and 19 show the output voltage and current waveforms of an electronic transformer driving a LED device with the stabilizing circuit shown in FIG. 11D. In this embodiment, the bypass portion of the circuit includes an inductor Lp in series with a capacitor Cp. Again the bypass current is limited by the inductor Lp in this embodiment, and there are short discontinuous periods in the waveforms. The peak current is also reduced.

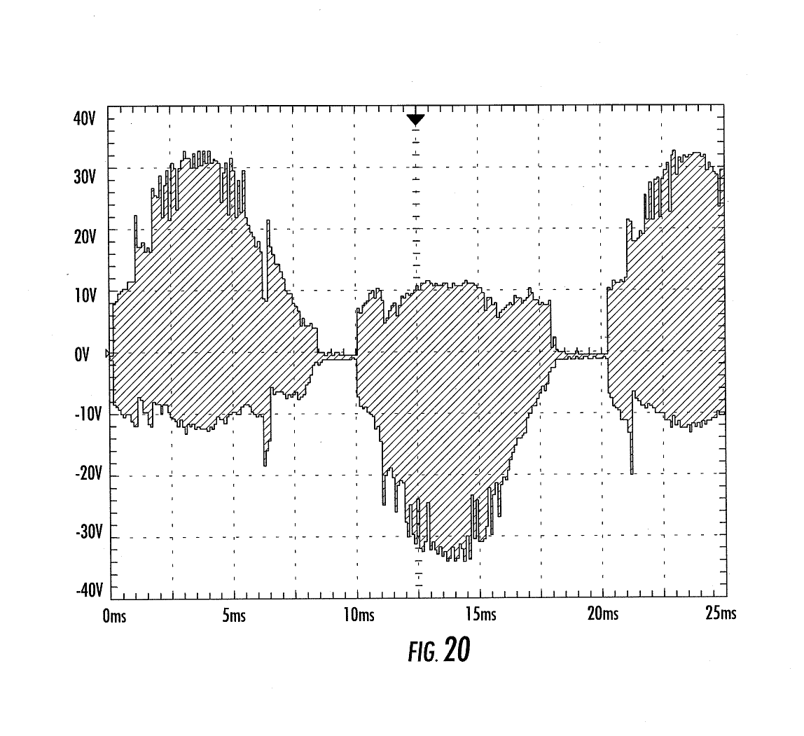

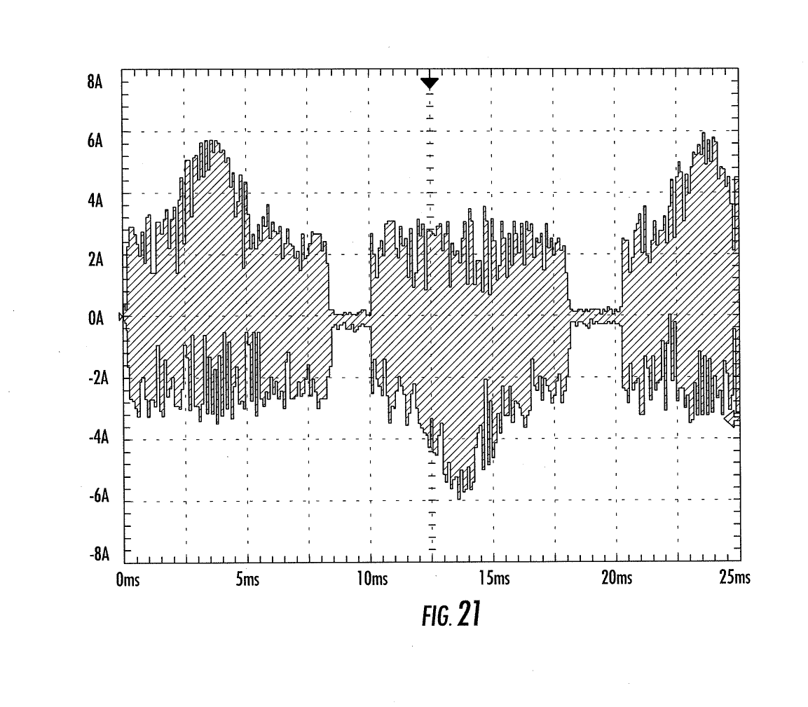

FIGS. 20 and 21 show the output voltage and current waveforms of an electronic transformer driving a LED device with the stabilizing circuit shown in FIG. 11E. In this embodiment, the bypass current is not limited, the waveforms are continuous over a half line cycle. However, the peak current is higher than other embodiments due to increased bypass current.

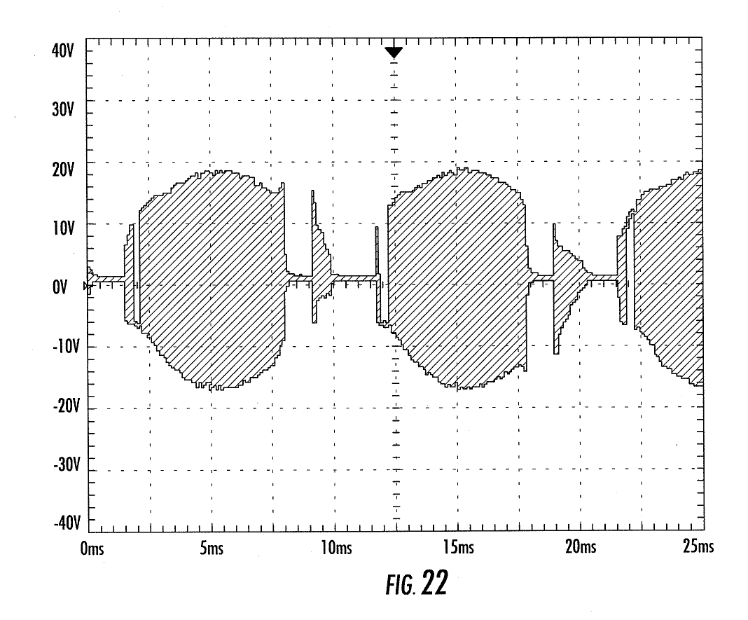

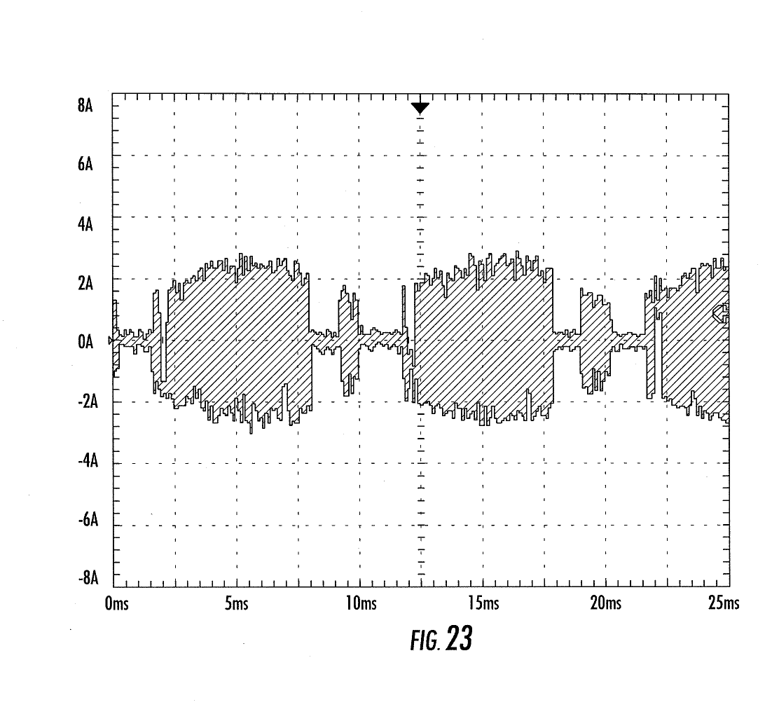

FIGS. 22 and 23 show the output voltage and current waveforms of an electronic transformer driving a LED device with the stabilizing circuit shown in FIG. 11F. Since the bypass current path is removed in this embodiment, there are discontinuous periods in the waveforms. Again, the peak current is reduced.

The stabilizing network in accordance with the preferred embodiments discussed above has a significant effect in keeping electronic transformers working properly and reducing output peak currents when electronic transformers are used to drive LED devices.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A stabilization circuit provided at an output of an electronic transformer driving circuit having a rectifier fed into a feedback-controlled oscillator circuit that drives an isolation transformer at an output of the electronic transformer driving circuit, the stabilization circuit comprising:
a current limiting portion that limits an amount of current delivered by the electronic transformer driving circuit.

2. The stabilization circuit of claim 1, further comprising:
a bypass current path that maintains stable operation of the feedback-controlled oscillator to regulate the current that flows to an output of the electronic transformer driving circuit.

3. The stabilization circuit of claim 2, wherein the bypass current path includes a resistor in series with a capacitor.

4. The stabilization circuit of claim 2, wherein the bypass current path includes, a resistor, an inductor, and a capacitor in series.

5. The stabilization circuit of claim 2, wherein the bypass current path includes a capacitor in series with a parallel combination of an inductor and a resistor.

6. The stabilization circuit of claim 2, wherein the bypass current path includes a capacitor and a resistor in series with a parallel combination of an inductor and a second resistor.

7. The stabilization circuit of claim 2, wherein the bypass current path includes an inductor in series with a capacitor.

8. The stabilization circuit of claim 2, wherein the bypass current path includes a capacitor.

9. The stabilization circuit of any of claims 1-8, wherein the current limiting portion includes a current limiting resistor in series with a current limiting inductor.

10. The stabilization circuit of any of claims 1-8, wherein the current limiting portion includes a current limiting inductor.
